(19) United States
(12) Patent Application Publication
(10) Pub. No.: US 2025/0053463 A1
(43) Pub. Date: Feb. 13, 2025

(54) DELIVERABLE NOTIFICATION PRIORITIZATION

(71) Applicant: INTERNATIONAL BUSINESS MACHINES CORPORATION, ARMONK, NY (US)

(72) Inventors: Badekila Ganesh Prashanth Bhat, Bangalore (IN); Manvendra Jina, Haldwani (IN); Ankit Naik, Bangalore (IN); Ajay Chebbi, Bangalore (IN)

(21) Appl. No.: 18/447,289

(22) Filed: Aug. 9, 2023

(51) Int. Cl. G06F 9/54; G06F 9/48

(52) U.S. Cl. CPC G06F 9/542; G06F 9/4881

(57) ABSTRACT

A computer-implemented method and system for prioritizing notifications deliverable to one or more end users include a notifications service identifier identifying one or more end user notification receiving devices. A notifications service server sends a first batch of one or more notifications to the one or more end user notification receiving devices. A notifications service monitor monitors delivery status information relative to each of the one or more notifications of the first batch. A notifications service collector collects the delivery status information. A notifications service calculator determines an end user notification preference score for each of the one or more end user notification receiving devices using the delivery status information.

### BACKGROUND

### Technical Field

The present disclosure generally relates to methods and systems for notification delivery, and more particularly, to methods and systems for prioritizing deliverable notifications based on notification habits of an end user.

### Description of the Related Art

Salient engagement of end users is important for all enterprises. This is particularly important for B2C enterprises. Examples include e-commerce sites such as Amazon® (a registered trademark of Amazon.com, Inc.) and Apple® (a registered trademark of Apple, Inc.), which sells iPhones, financial services, etc. An increased engagement with end users can typically result in a competitive edge for such enterprises.

One important way to engage with end users is through notifications. Enterprises provide the latest offers, information relating to the latest products, event information, etc. Notifications including this information are typically provided to the end user with the intention that this information is useful for the end-user, which can more easily result in an interaction with the sender. As an example, a notification about an upcoming availability or a new version of a mobile phone can be sent to all registered users. Similarly, the latest news can be sent out as notifications by banks, various services, etc. These enterprises typically use a variety of notification channels to notify their end users that include push notifications, emails, short message system (SMS) messages, WhatsApp® (a registered trademark of Whatsapp Inc.) messages, etc.

An enterprise can have millions of registered users to whom notifications are sent. A media site, for example, may decide to send a sports news broadcast to all subscribed users and on all channels to which a user can be reached. Similarly, a utility company may need to send a consumption reminder to a million end users on all their customers' respective subscribed channels. Event notifications services on, for example, the IBM® (a registered trademark of International Business Machines Corporation) Cloud catalog helps configure several such channels and allows enterprises to send notifications to multiple subscribed devices/phone numbers/emails of users. This can include service-to-people channels (such as email, push notifications, etc.) or service-to-service channels (such as webhooks, serverless functions, etc.). As a user of event notifications, an enterprise can manage users from several channels/destinations. The enterprise can then “fan-out” a single message to several channels all at once, or send individual messages across users in multiple channels.

Typically, a business owner sending notifications would prefer to deliver a new offer/campaign to all subscribed recipients on all their channels instantaneously and in a resource-efficient way. From the Cloud provider's perspective (for example, the event notifications service perspective), fast, efficient, and timely delivery of notifications at the scale of millions of devices and end users is a challenge. A single message broadcast may have to reach millions of users and several channels for each user. The computational overhead to perform this task instantaneously (or within milliseconds) becomes prohibitive due to the cloud infrastructure required to process each user/channel. Keeping the computational resources reasonable implies that there can be a time lag to process all of the users and all of their subscribed channels, as well as delivery of the messages to the users. The problem is exacerbated when a multi-tenanted service offering is considered, which is shared by multiple customers. Each customer usually expects a near-instantaneous delivery and needs to get a feeling of a dedicated service for each offering.

### SUMMARY

According to an embodiment of the present disclosure, a computer-implemented method for prioritizing notifications deliverable to one or more end users includes a notifications service server including a notifications service identifier and a notifications service calculator. A notifications service monitor including a notifications service collector are additionally utilized to carry out the computer-implemented method. The method includes identifying, by the notifications service identifier, one or more end user notification receiving devices. The notifications service server then sends a first batch of one or more notifications to the one or more end user notification receiving devices. Once the notifications service server sends the first batch of one or more notifications, the notifications service monitor then monitors delivery status information relative to each of the one or more notifications of the first batch. The notifications service collector then collects the delivery status information. Once the notifications service collector collects the delivery status information, the notifications service calculator determines an end user notification preference score for each of the one or more end user notification receiving devices using the delivery status information. The method is advantageous in that the dynamic identification of end users based on notification habits leads to the saving of computational resources relative to increased accuracy of notification targeting of end users.

In one embodiment, which can be combined with the previous embodiment, each of the one or more end user notification receiving devices include a separate end user notification preference score for each of one or more defined timeslots. This determining provides a more efficient way to increase the accuracy of notification targeting of end users.

In another embodiment, which can be combined with the previous embodiments, the end user notification preference score includes at least one of: a probability of a message relative to a respective one of the one or more notifications reaching a respective one of the one or more end user notification receiving devices or a probability of the message relative to a respective one of the one or more notifications being opened by a respective one of the one or more end users. Each of these probabilities are particularly suited for use with the disclosed notification prioritization.

In another embodiment, which can be combined with one or more previous embodiments, the delivery status information includes a first response time by each of the one or more end users during one or more defined timeslots.

In another embodiment, which can be combined with one or more previous embodiments, the method further includes sending, via the notifications service server, at least one additional batch of one or more notifications to the one or more end user notification receiving devices during one or more defined timeslots. Each of the one or more notifications of the at least one additional batch are sent to the one or more additional receiving devices at timed intervals during at least one of the one or more defined timeslots based on the first response time of each of the one or more end users. By virtue of this feature, a more efficient notifications sending is provided.

In another embodiment, which can be combined with one or more previous embodiments, the method further includes redetermining, via the notifications service calculator, the end user notification preference score for each of the one or more end user notification receiving devices using at least one additional response time of each of the one or more end users to the at least one additional batch of one or more notifications.

In another embodiment, which can be combined with one or more previous embodiments, the sending further comprises scheduling, via the notifications service server, at least one batch job configured to send at least one of the first batch of the one or more notifications or the at least one additional batch of the one or more notifications at regular intervals. The sending of the notifications using batch jobs is more efficient with the prioritization of notifications.

According to an embodiment of the present disclosure, a computer program product for reducing computing resources by prioritizing notifications deliverable to one or more end users is provided. The computer program product includes a computer readable storage medium embodying program instructions executable by a processor to cause the processor to perform a plurality of steps. A notifications service identifier identifies one or more end user notification receiving devices. A notifications service server then sends a first batch of one or more notifications to the one or more end user notification receiving devices. Once the notifications service server sends the first batch of one or more notifications, a notifications service monitor then monitors delivery status information relative to each of the one or more notifications of the first batch. A notifications service collector then collects the delivery status information. Once the notifications service collector collects the delivery status information, a notifications service calculator determines an end user notification preference score for each of the one or more end user notification receiving devices using the delivery status information. The computer program product is advantageous in that the dynamic identification of end users based on notification habits leads to the saving of computational resources relative to increased accuracy of notification targeting of end users.

In one embodiment, which can be combined with the previous embodiment, each of the one or more end user notification receiving devices comprise a separate end user notification preference score for each of one or more defined timeslots. This determining provides a more efficient way to increase the accuracy of notification targeting of end users.

In another embodiment, which can be combined with one or more previous embodiments, the delivery status information includes a first response time by each of the one or more end users during one or more defined timeslots.

In another embodiment, which can be combined with the previous embodiments, the computer program product further includes sending, via the notifications service server, at least one additional batch of one or more notifications to the one or more end user notification receiving devices during one or more defined timeslots. Each of the one or more notifications of the at least one additional batch are sent to the one or more additional receiving devices at timed intervals during at least one of the one or more defined timeslots based on the first response time of each of the one or more end users. By virtue of this feature, a more efficient notifications sending is provided.

In another embodiment, which can be combined with one or more previous embodiments, the computer program product further includes redetermining, via the notifications service calculator, the end user notification preference score for each of the one or more end user notification receiving devices using at least one additional response time of each of the one or more end users to the at least one additional batch of one or more notifications.

In another embodiment, which can be combined with one or more previous embodiments, the sending further comprises scheduling, via the notifications service server, at least one batch job configured to send at least one of the first batch of the one or more notifications or the at least one additional batch of the one or more notifications at regular intervals. The sending of the notifications using batch jobs is more efficient with the prioritization of notifications.

According to an embodiment of the present disclosure, a computing system is provided. There is a processor, a network module coupled to the processor to enable communication over a network, and a computer-readable storage device coupled to the processor. A notifications service server is coupled to the processor and the network module, where the notifications service server includes a notifications service identifier and a notifications service calculator. A notifications service monitor is coupled to the processor. The notifications service monitor includes a notifications service collector. Program instructions are stored on the non-transitory computer-readable storage device for execution by the processor via a memory.

According to an embodiment of the present disclosure, a computing system, in conjunction with the program instructions, is configured to perform a deliverable end user notifications prioritization to conserve computing resources method. The notifications service identifier identifies one or more end user notification receiving devices. The notifications service server then sends a first batch of one or more notifications to the one or more end user notification receiving devices. Once the notifications service server sends the first batch of one or more notifications, the notifications service monitor then monitors delivery status information relative to each of the one or more notifications of the first batch. The notifications service collector then collects the delivery status information. Once the notifications service collector collects the delivery status information, the notifications service calculator determines an end user notification preference score for each of the one or more end user notification receiving devices using the delivery status information. The computing system is advantageous in that the dynamic identification of end users based on notification habits leads to the saving of computational resources relative to increased accuracy of notification targeting of end users.

In one embodiment, which can be combined with the previous embodiment, each of the one or more end user notification receiving devices comprise a separate end user notification preference score for each of one or more defined timeslots. This determining provides a more efficient way to increase the accuracy of notification targeting of end users.

In another embodiment, which can be combined with one or more previous embodiments, the end user notification preference score includes at least one of: a probability of a message relative to a respective one of the one or more notifications reaching a respective one of the one or more end user notification receiving devices or a probability of the message relative to a respective one of the one or more notifications being opened by a respective one of the one or more end users. Each of these probabilities are particularly suited for use with the disclosed notification prioritization.

In another embodiment, which can be combined with one or more previous embodiments, the delivery status information includes a first response time by each of the one or more end users during one or more defined timeslots.

In another embodiment, which can be combined with one or more previous embodiments, the computing system further includes sending, via the notifications service server, at least one additional batch of one or more notifications to the one or more end user notification receiving devices during one or more defined timeslots. Each of the one or more notifications of the at least one additional batch are sent to the one or more additional receiving devices at timed intervals during at least one of the one or more defined timeslots based on the first response time of each of the one or more end users. By virtue of this feature, a more efficient notifications sending is provided.

In another embodiment, which can be combined with one or more previous embodiments, the computing system further includes redetermining, via the notifications service calculator, the end user notification preference score for each of the one or more end user notification receiving devices using at least one additional response time of each of the one or more end users to the at least one additional batch of one or more notifications.

In another embodiment, which can be combined with one or more previous embodiments, the sending further comprises scheduling, via the notifications service server, at least one batch job configured to send at least one of the first batch of the one or more notifications or the at least one additional batch of the one or more notifications at regular intervals. The sending of the notifications using batch jobs is more efficient with the prioritization of notifications.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a functional block diagram illustration of a computing environment that can communicate with various networked components, consistent with an illustrative embodiment.

FIG. 2 presents a computing system for prioritizing notifications deliverable to one or more end users, consistent with an illustrative embodiment.

FIG. 3 is a flowchart showing an exemplary process of notification delivery of a system for prioritizing notifications deliverable to one or more end users, consistent with an illustrative embodiment.

FIG. 4 is a call-flow showing an additional exemplary process of notification delivery of a system for prioritizing notifications deliverable to one or more end users, consistent with an illustrative embodiment.

FIG. 5 is a flowchart showing an exemplary process of prioritizing notifications deliverable to one or more end users performed in the computing system shown in FIG. 2, consistent with an illustrative embodiment.

FIG. 6 is a flowchart showing an additional exemplary process of prioritizing notifications deliverable to one or more end users performed in the computing system shown in FIG. 2, consistent with an illustrative embodiment.

FIG. 7 is a flowchart for a computer-implemented method for prioritizing notifications deliverable to one or more end users, consistent with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Considering computational resources, business owners (who engage with their customers through notifications) should be able to engage their most active users so that their most active users can receive notifications first. For the purposes of this disclosure, “active users” may refer to users that tend to open notifications faster than others. There is also a case where some users prefer one channel over another (for example, a user that prefers Whatsapp®, over push notifications and additionally prefers push notifications over emails). This can allow a notification sender to “engage” with a larger set of users in a given timeframe. However, a list of end users/devices that are subscribed to a service is dynamic and changes over time. Additionally, active users change over time and the types of notifications sent can affect the response rate (for example, some end users are interested in particular categories of notifications, which can also change over time). Deducing the trend of active users for application owners by certain factors (such as, for example, event type notification type, etc.) and prioritizing active users over other users is a challenge.

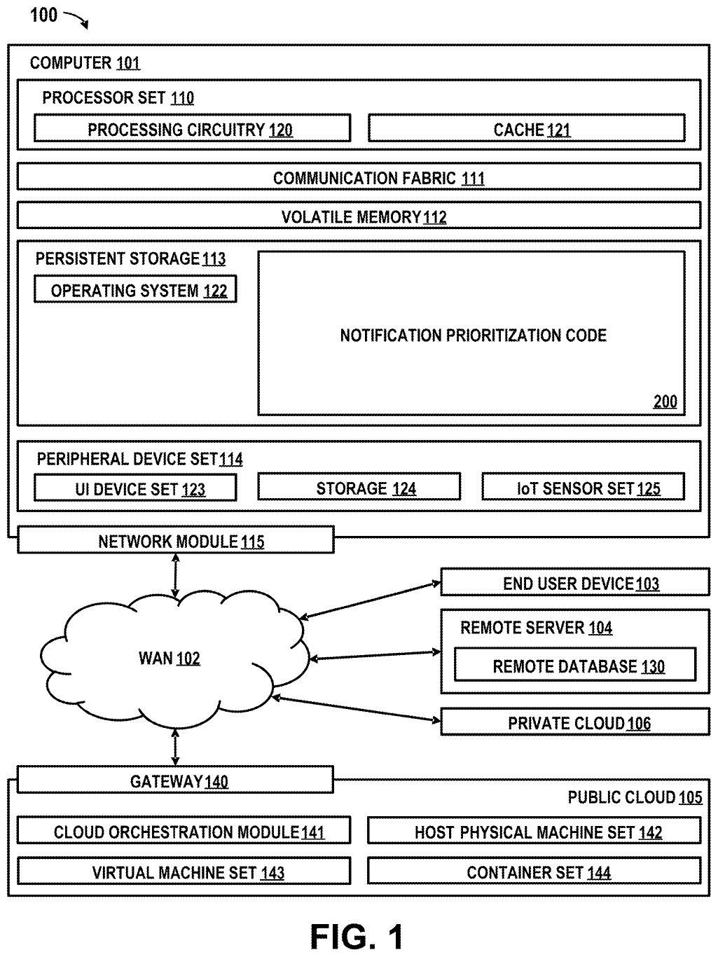

FIG. 1 is a functional block diagram illustration of a computing environment 100 that can communicate with various networked components, such as the cloud, a policy data source, etc. In particular, FIG. 1 illustrates a computing environment 100, as may be used to implement a component, such as, for example, a notifications service identifier 225, a notifications service calculator 230, a notifications service monitor 235, and a notifications service collector 240.

Computing environment 100 includes an example of an environment for the execution of at least some of the computer code involved in performing the inventive methods, such as notification prioritization code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure generally relates to computer-implemented methods for prioritizing notifications deliverable to one or more end users. By virtue of the concepts discussed herein, monitoring and identification of time-based notification habits of end users are utilized to generate increased accuracy of notification targeting of end users for enterprises.

### Example Architecture

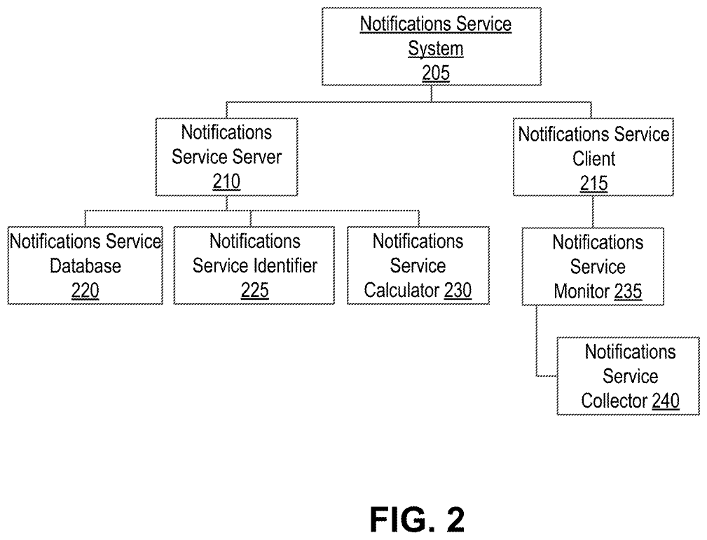

Reference is now made to FIG. 2, which presents a computing system 205 for prioritizing notifications deliverable to one or more end users, consistent with an illustrative embodiment. For purposes of this disclosure, computing system 205 can be alternately referred to as a notifications service system 205. It is noted that notifications service server 210 and notifications service client 215 include, together or separately, one or more of: a memory, a network module, a processor, a GUI, and a non-transitory computer-readable storage medium.

The network module provides coupling between various components of computing system 205 so that time-based notification habit data of end users is shared between the components that are configured to prioritize the notifications deliverable to the one or more end users and include notifications service server 210 (housing notifications service database 220, notifications service identifier 225, and notifications service calculator 230) and notifications service client 215 (housing notifications service monitor 235). The network module is coupled to the processor to enable the processor communication over a network established by the network module. Additionally, the non-transitory computer-readable storage device and the graphical user interface (GUI) are coupled to the processor.

The GUI is coupled to the processor to enable communication between computing system 205 and a user/administrator of computing system 205.

Notifications service database 220, via notifications service server 210, is coupled to network module to enable storage and distribution of time-based notification habit data to the other components of computing system 205.

Notifications service identifier 225, via notifications service server 210, is coupled to the processor to enable analysis of the time-based notification habit data.

Notifications service calculator 230, via notifications service server 210, is coupled to the processor to enable determination of an end user notification preference score for one or more end user notification receiving devices.

Notifications service monitor 235, via notifications service client 215, is coupled to the processor to enable the monitoring of delivery status information relative to batched notifications for end users. Notifications service monitor 235 includes notifications service collector 240.

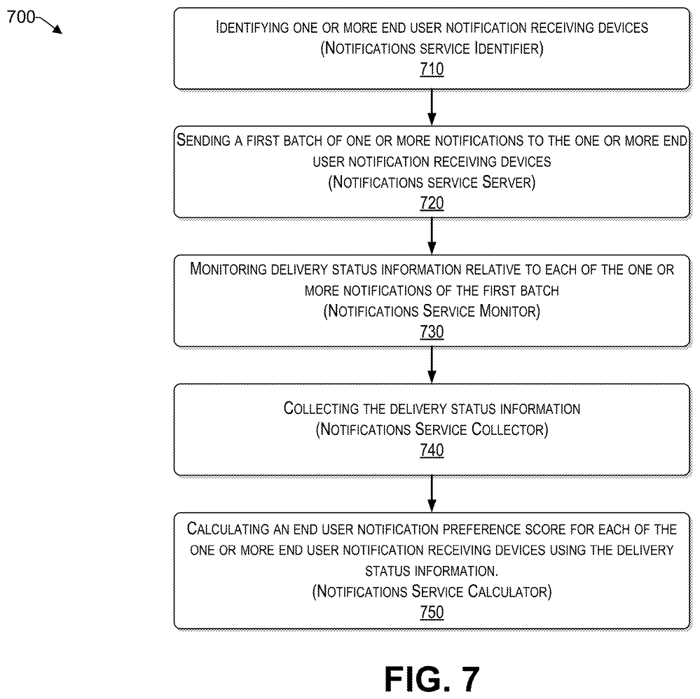

Program instructions (sometimes referred to as notification prioritization code at block 200) stored on the non-transitory computer-readable storage device are configured for execution by the processor via a memory (similar to the volatile memory 112 of FIG. 1) coupled to the processor. The instructions are configured to render computing system 205 capable of performing a number of operations in a computer-implemented method for prioritizing notifications deliverable to one or more end users (presented similarly in FIG. 7). The method includes identifying, by the notifications service identifier 225, one or more end user notification receiving devices. The notifications service server 210 then sends a first batch of one or more notifications to the one or more end user notification receiving devices. Once the notifications service server 210 sends the first batch of one or more notifications, the notifications service monitor 235 then monitors delivery status information relative to each of the one or more notifications of the first batch. The notifications service collector 240 then collects the delivery status information. Once the notifications service collector 240 collects the delivery status information, the notifications service calculator 230 determines an end user notification preference score for each of the one or more end user notification receiving devices using the delivery status information. The computing system 205/method is advantageous in that the dynamic identification of end users based on notification habits leads to the saving of computational resources relative to increased accuracy of notification targeting of end users.

In one embodiment, computing system 205 includes multiple computer systems (for example, one server and multiple clients). In a further embodiment, computing system 205 includes a single computer system (for example, a server program and a client program).

In one embodiment, each of the one or more end user notification receiving devices include a separate end user notification preference score for each of one or more defined timeslots. This determining provides a more efficient way to increase the accuracy of notification targeting of end users.

In one embodiment, the end user notification preference score includes at least one of: a probability of a message relative to a respective one of the one or more notifications reaching a respective one of the one or more end user notification receiving devices or a probability of the message relative to a respective one of the one or more notifications being opened by a respective one of the one or more end users. Each of these probabilities are particularly suited for use with the disclosed notification prioritization.

In one embodiment, the delivery status information includes a first response time by each of the one or more end users during one or more defined timeslots.

In one embodiment, execution of the instructions by the processor configures computing system 205 to additionally perform sending, via the notifications service server 210, at least one additional batch of one or more notifications to the one or more end user notification receiving devices during one or more defined timeslots, where each of the one or more notifications of the at least one additional batch are sent to the one or more additional receiving devices at timed intervals during at least one of the one or more defined timeslots based on a first response time of each of the one or more end users. By virtue of this feature, a more efficient notifications sending is provided.

In one embodiment, execution of the instructions by the processor configures computing system 205 to additionally perform redetermining, via the notifications service calculator 230, the end user notification preference score for each of the one or more end user notification receiving devices using at least one additional response time of each of the one or more end users to the at least one additional batch of one or more notifications.

In one embodiment, the sending further comprises scheduling, via the notifications service server 210, at least one batch job configured to send at least one of the first batch of the one or more notifications or the at least one additional batch of the one or more notifications at regular intervals. The sending of the notifications using batch jobs is more efficient with the prioritization of notifications.

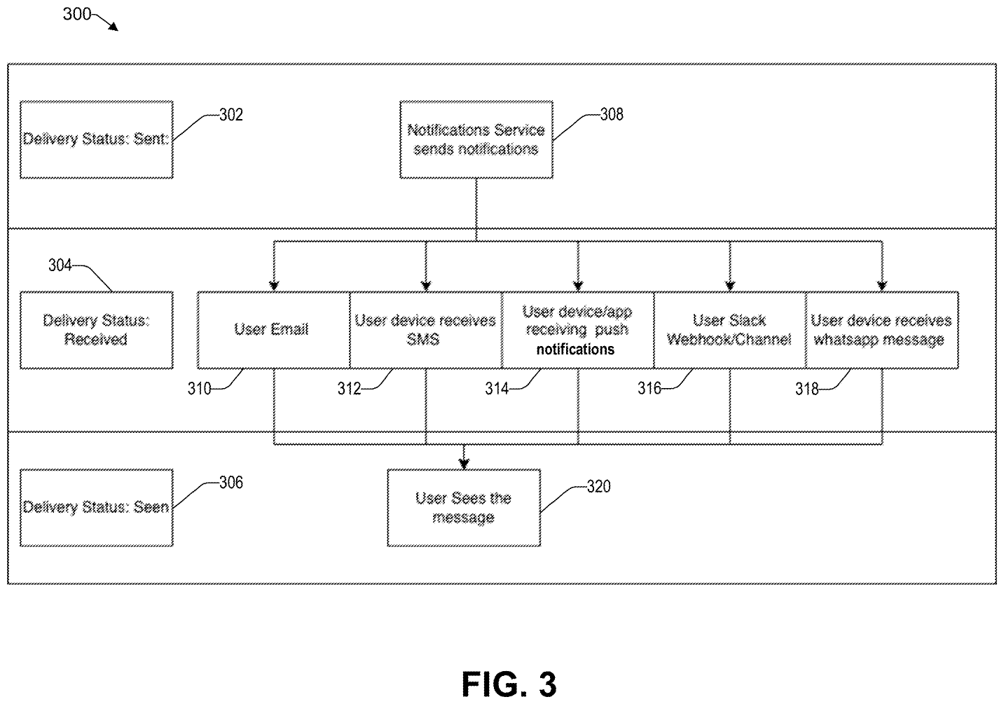

According to an embodiment, a computer program product for reducing computing resources by prioritizing notifications deliverable to one or more end users is provided. The computer program product includes a computer readable storage medium embodying program instructions executable by a processor to cause the processor to perform a plurality of steps. These steps may correlate to any process steps/functions relative to any of FIGS. 3-7.

Reference is now made to FIG. 3, which is a flowchart 300 showing an exemplary process of notification delivery of a system for prioritizing notifications deliverable to one or more end users, consistent with an illustrative embodiment. For discussion purposes, the flowchart 300 is described with reference to the architecture of environment 100 and computing system 205 of FIGS. 1 and 2.

As shown, at block 308, notifications service server 210 sends notifications to one or more end user notification receiving devices. At block 302 (associated with the actions in block 308), notifications service server 210 associates a delivery status of “sent” to the sent notifications and stores the delivery status information in notifications service database 220.

At blocks 310, 312, 314, 316, and 318, end user notification receiving devices receive notifications from notifications service server 210 in the form of an email at block 310, an SMS message at block 312, push notifications of a user device/application at block 314, a webhook/channel of an application at block 316 (for example, Slack®, a registered trademark of Slack Technologies), and a Whatsapp® message at block 318. At block 304 (associated with the actions in blocks 310, 312, 314, 316, and 318), notifications service server 210 associates a delivery status of “received” to the received notifications and stores the delivery status information in notifications service database 220.

At block 320, a user of each of the end user notification receiving devices sees the notifications/messages. At block 306 (associated with the actions in block 320), notifications service server 210 associates a delivery status of “seen” to the seen notifications and stores the delivery status information in notifications service database 220.

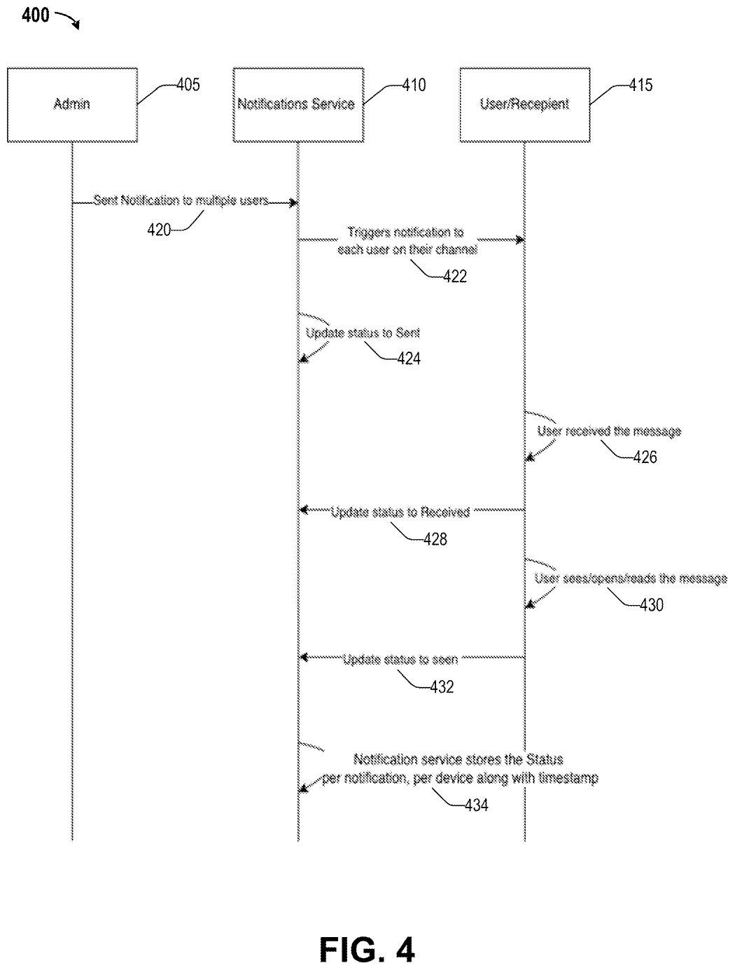

Reference is now made to FIG. 4, which is a call-flow 400 showing an additional exemplary process of notification delivery of a system for prioritizing notifications deliverable to one or more end users, consistent with an illustrative embodiment. For discussion purposes, the call-flow 400 is described with reference to the architecture of environment 100 and computing system 205 of FIGS. 1 and 2.

As shown, at block 405, an administrator controls the functionality of computing system 205. At block 420, the administrator sends a notification to multiple end user notification receiving devices. At block 410, a notifications service 410 (utilizing notifications service server 210) controls the sending of the notification to the multiple users. At block 422, the notification service triggers a notification alert to each user on their channel (relative to each end user notification receiving device the notification is assigned to). Once the notification leaves the notifications service, at block 424, the delivery status of the notification is updated to “sent”.

At block 415, a user/recipient is on a receiving end of the notification being sent. At block 426, end user notification receiving devices of users receive the notification in the form of a message. Once the notification is received on each of the end user notification receiving devices, at block 428, the status of the notification for each end user notification receiving devices is updated from “sent” to “received” by the notifications service. Subsequently, users/recipients of each of the end user notification receiving devices see, open, and/or read the messages related to the notification at block 430. Once the notification is seen, open, and/or read on each of the end user notification receiving devices, at block 432, the status of the notification for each end user notification receiving devices is updated from “received” to “seen” by the notifications service. Subsequently, at block 434, the notifications service stores the status for each notification sent, per device, including the timestamp of when messages have been read by users/recipients.

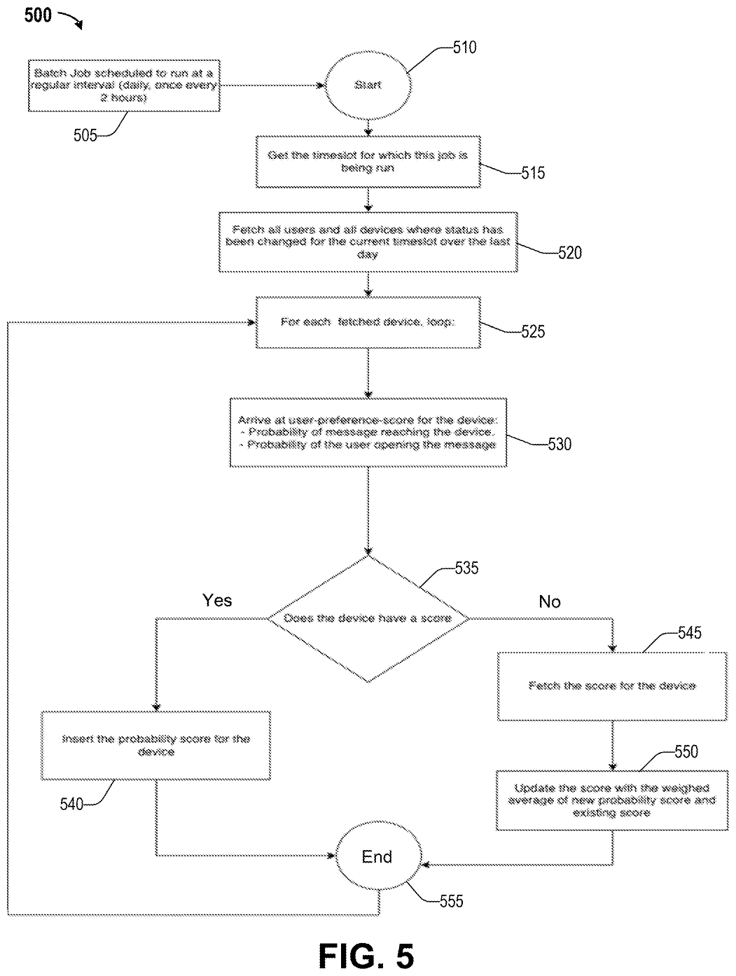

Reference is now made to FIG. 5, which is a flowchart 500 showing an exemplary process of prioritizing notifications deliverable to one or more end users performed in the computing system shown in FIG. 2, consistent with an illustrative embodiment. As shown, at block 505, a batch job for notifications is scheduled to run at a regular interval (for example, daily or once every two hours). At block 510 the process of prioritizing notifications deliverable to one or more end users begins. At block 515, notifications service monitor 235 identifies the timeslot during which the batch job is being run, where the timeslot information is communicated to the notifications service server 210. At block 520, all users and end user notification receiving devices are fetched (by notifications service monitor 235) that have had a status change for the current timeslot over the last day. At block 525, a loop is run for each fetched end user notification receiving device, where the loop encompasses blocks 530 through 555.

At block 530, an end user notification preference score is derived for the timeslot via a notifications service calculator 230, which can include at least one of: a probability of a message related to the notification reaching an end user notification receiving device or a probability of a user of an end user notification receiving device opening a message related to the notification. Scores associated with each of the end user notification receiving devices are stored in notifications service database 220.

At block 535, notifications service identifier 225 identifies if each end user notification receiving device has a previously associated end user notification preference score prior to the batch job being run. If an end user notification preference score is not associated with an end user notification receiving device, then, at block 540, the end user notification preference score derived at block 530 is stored in notifications service database 220 for each end user notification receiving device.

If an end user notification preference score is already associated with an end user notification receiving device, then, at block 545, the end user notification preference score is fetched from notifications service database 220 for each end user notification receiving device.

Subsequently, at block 550, the fetched end user notification preference score is updated with a weighted average of the end user notification preference score derived at block 530 and the fetched end user notification preference score. At block 555, the process ends.

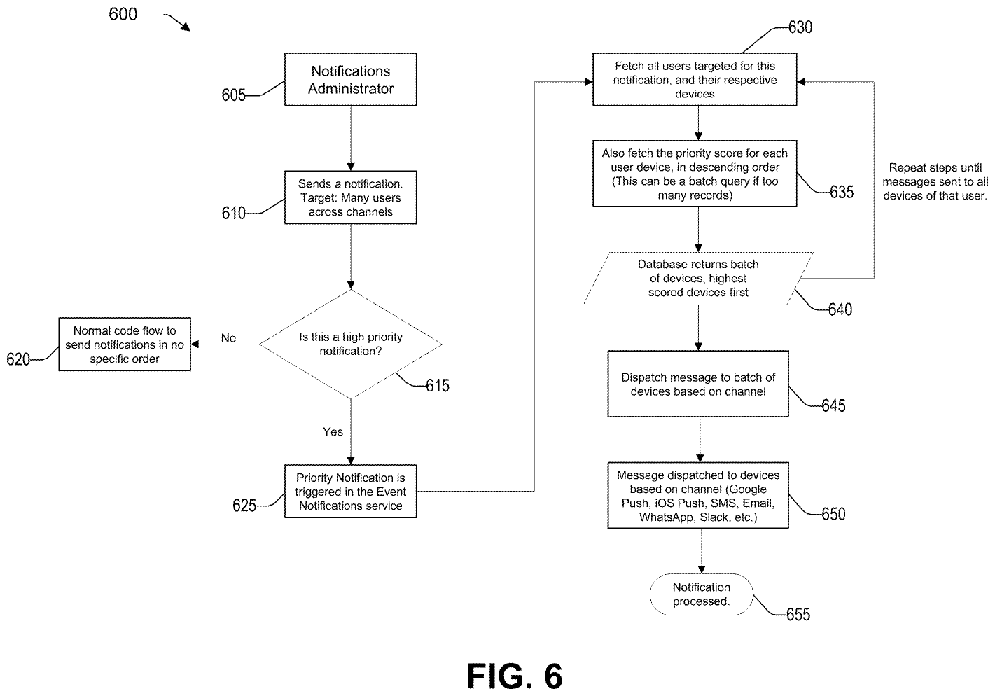

Reference is now made to FIG. 6, which is a flowchart 600 showing an additional exemplary process of prioritizing notifications deliverable to one or more end users performed in the computing system shown in FIG. 2, consistent with an illustrative embodiment. As shown, at block 605, a computer-implemented notifications administrator that controls the functionality of computing system 205 is presented. At block 610, a notification is sent by notifications administrator to multiple end user notification receiving devices.

At block 615, notifications service identifier 225 identifies if an application is a high priority notification. For the purposes of this disclosure, the term “high priority notification” refers to a notification sent out by a notifications administrator that is prioritized to reach end users that are more responsive than end users that are less responsive. For the notifications that are not labeled as high priority, a normal code flow of the notifications are carried out, where the non-high priority notifications are sent to end users in no specific order.

For the notifications that are labeled as high priority, at block 625, the notifications are identified by notifications service server 210 as a priority notification and, at block 630, users/end user notification receiving devices targeted for the priority notifications (ordered in relation to responsiveness) are identified/fetched.

At block 635, priority scores for each end user notification receiving device are fetched in a descending order based on the priority scores. In embodiments, the priority scores can be fetched as a batch query.

At block 640, notifications service database 220 returns a batch of end user notification receiving devices, where the highest scored devices are prioritized/identified first. It is noted that blocks 630 through 640 are repeated until notifications/messages are sent to all end user notification receiving device of each end user.

At block 645, messages relative to the notifications are dispatched to end user notification receiving devices based on the channel in which they are received. At block 650, the messages relative to the notifications are dispatched to the end user notification receiving devices based on the channel to which they are associated. In an embodiment, channels include, but are not limited to: Google® (a registered trademark of Google Inc.), push notifications, iOS push notifications, SMS, email, Whatsapp®, or Slack®. At block 655, the notification is processed in relation to the channels. In a further embodiment, channels additionally include other services or applications capable of sending and receiving messages.

With the foregoing overview of the example architecture/environment/computing system 100, 205, it may be helpful to consider a high-level discussion of an example process. To that end FIG. 7 presents a flowchart 700 for prioritizing notifications deliverable to one or more end users, consistent with an illustrative embodiment.

Flowchart 700 is illustrated as a process in logical flowchart format, wherein the flowchart represents a sequence of operations that can be implemented in hardware, software, or a combination thereof. In the context of software, the process represents computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described processes can be combined in any order and/or performed in parallel to implement the process. For discussion purposes, the computer-implemented method for prioritizing notifications deliverable to one or more end users is described with reference to the architecture of environment 100 and system 205 of FIGS. 1 and 2.

At block 710, a notifications service identifier 225 identifies one or more end user notification receiving devices.

At block 720, a notifications service server 210 sends a first batch of one or more notifications to the one or more end user notification receiving devices.

At block 730, a notifications service monitor 235 monitors delivery status information relative to each of the one or more notifications of the first batch.

At block 740, a notifications service collector 240 collects the delivery status information.

At block 750, a notifications service calculator 230 determines an end user notification preference score for each of the one or more end user notification receiving devices using the delivery status information. The method is advantageous in that the dynamic identification of end users based on notification habits leads to the saving of computational resources relative to increased accuracy of notification targeting of end users.

In one embodiment, each of the one or more end user notification receiving devices may comprise a separate end user notification preference score for each of the one or more defined timeslots. This determining provides a more efficient way to increase the accuracy of notification targeting of end users.

In a further embodiment, the end user notification preference score includes at least one of: a probability of a message relative to a respective one of the one or more notifications reaching a respective one of the one or more end user notification receiving devices or a probability of the message relative to a respective one of the one or more notifications being opened by a respective one of the one or more end users. Each of these probabilities are particularly suited for use with the disclosed notification prioritization.

The delivery status information can include a first response time by each of the one or more end users during one or more defined timeslots.

In a further embodiment, the integration workflow of flowchart 700 further includes sending, via the notifications service server 210, at least one additional batch of one or more notifications to the one or more end user notification receiving devices during one or more defined timeslots, where each of the one or more notifications of the at least one additional batch are sent to the one or more additional receiving devices at timed intervals during at least one of the one or more defined timeslots based on a first response time of each of the one or more end users. By virtue of this feature, a more efficient notifications sending is provided.

In a further embodiment, the integration workflow of flowchart 700 further includes redetermining, via the notifications service calculator 230, the end user notification preference score for each of the one or more end user notification receiving devices using at least one additional response time of each of the one or more end users to the at least one additional batch of one or more notifications.

In a further embodiment, the sending further comprises scheduling, via the notifications service server 210, at least one batch job configured to send at least one of the first batch of the one or more notifications or the at least one additional batch of the one or more notifications at regular intervals. The sending of the notifications using batch jobs is more efficient with the prioritization of notifications.

For the purposes of this disclosure, in relation to notification receiving devices, “user” and “end user” may be used interchangeably. It is understood that an end user notification receiving device can be characterized by information identifying a user on a specific destination, as opposed to a physical configuration of a user device. For example, a user email ID and a user slack webhook/channel URL can be characterized as an end user notification receiving device, as opposed to the actual device (mobile electronic device) that receives the messages.

For the purposes of this disclosure, the terms “notification” and “message” may be used interchangeably. Additionally, the term “notification” may be utilized in the context of an administrator associated with computing system 205, while the term “message” may be utilized in the context of an end user associated with an end user notification receiving device.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may obviate a need for time consuming data processing by the user. This may have the technical effect of reducing computing resources used by one or more devices within the system. Additionally, one or more of the methodologies discussed herein may obviate a need for inefficient prioritization of end user notifications. This may also have the technical effect of reducing computer resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for prioritizing notifications deliverable to one or more end users using a notifications service server including a notifications service identifier and a notifications service calculator; and a notifications service monitor including a notifications service collector; the method comprising:
identifying, by the notifications service identifier, one or more end user notification receiving devices;
sending, via the notifications service server, a first batch of one or more notifications to the one or more end user notification receiving devices;
monitoring, by the notifications service monitor, delivery status information relative to each of the one or more notifications of the first batch;
collecting, via the notifications service collector, the delivery status information; and
determining, via the notifications service calculator, an end user notification preference score for each of the one or more end user notification receiving devices using the delivery status information.

2. The method of claim 1, wherein each of the one or more end user notification receiving devices comprise a separate end user notification preference score for each of one or more defined timeslots.

3. The method of claim 2, wherein the end user notification preference score includes at least one of: a probability of a message relative to a respective one of the one or more notifications reaching a respective one of the one or more end user notification receiving devices or a probability of the message relative to a respective one of the one or more notifications being opened by a respective one of the one or more end users.

4. The method of claim 1, wherein the delivery status information includes a first response time by each of the one or more end users during one or more defined timeslots.

5. The method of claim 4, further comprising sending, via the notifications service server, at least one additional batch of one or more notifications to the one or more end user notification receiving devices during one or more defined timeslots, wherein each of the one or more notifications of the at least one additional batch are sent to the one or more additional receiving devices at timed intervals during at least one of the one or more defined timeslots based on the first response time of each of the one or more end users.

6. The method of claim 5, further comprising redetermining, via the notifications service calculator, the end user notification preference score for each of the one or more end user notification receiving devices using at least one additional response time of each of the one or more end users to the at least one additional batch of one or more notifications.

7. The method of claim 5, wherein the sending further comprises scheduling, via the notifications service server, at least one batch job configured to send at least one of the first batch of the one or more notifications or the at least one additional batch of the one or more notifications at regular intervals.

8. A computer program product for reducing computing resources by prioritizing notifications deliverable to one or more end users, the computer program product comprising a computer readable storage medium having program instructions embodied therewith, the program instructions executable by a processor to cause the processor to perform:
identifying, by a notifications service identifier, one or more end user notification receiving devices;
sending, via a notifications service server, a first batch of one or more notifications to the one or more end user notification receiving devices;
monitoring, by a notifications service monitor, delivery status information relative to each of the one or more notifications of the first batch;
collecting, via a notifications service collector, the delivery status information; and
determining, via a notifications service calculator, an end user notification preference score for each of the one or more end user notification receiving devices using the delivery status information.

9. The computer program product of claim 8, wherein each of the one or more end user notification receiving devices comprise a separate end user notification preference score for each of one or more defined timeslots.

10. The computer program product of claim 8, wherein the delivery status information includes a first response time by each of the one or more end users during one or more defined timeslots.

11. The computer program product of claim 10, further comprising sending, via the notifications service server, at least one additional batch of one or more notifications to the one or more end user notification receiving devices during one or more defined timeslots, wherein each of the one or more notifications of the at least one additional batch are sent to the one or more additional receiving devices at timed intervals during at least one of the one or more defined timeslots based on the first response time of each of the one or more end users.

12. The computer program product of claim 11, further comprising redetermining, via the notifications service calculator, the end user notification preference score for each of the one or more end user notification receiving devices using at least one additional response time of each of the one or more end users to the at least one additional batch of one or more notifications.

13. The computer program product of claim 11, wherein the sending further comprises scheduling, via the notifications service server, at least one batch job configured to send at least one of the first batch of the one or more notifications or the at least one additional batch of the one or more notifications at regular intervals.

14. A computing system comprising:
a processor;
a network module coupled to the processor to enable communication over a network;
a computer-readable storage device coupled to the processor;
a notifications service server coupled to the processor and the network module, the notifications service server including a notifications service identifier and a notifications service calculator;
a notifications service monitor coupled to the processor, the notifications service monitor including a notifications service collector;
program instructions stored on the computer-readable storage device for execution by the processor via a memory, wherein execution of the instructions by the processor configures the computing device to perform a deliverable end user notifications prioritization to conserve computing resources method comprising:
identifying, by the notifications service identifier, one or more end user notification receiving devices;
sending, via the notifications service server, a first batch of one or more notifications to the one or more end user notification receiving devices;
monitoring, by the notifications service monitor, delivery status information relative to each of the one or more notifications of the first batch;
collecting, via the notifications service collector, the delivery status information; and
determining, via the notifications service calculator, an end user notification preference score for each of the one or more end user notification receiving devices using the delivery status information.

15. The computing system of claim 14, wherein each of the one or more end user notification receiving devices comprise a separate end user notification preference score for each of one or more defined timeslots.

16. The computing system of claim 15, wherein the end user notification preference score includes at least one of: a probability of a message relative to a respective one of the one or more notifications reaching a respective one of the one or more end user notification receiving devices or a probability of the message relative to a respective one of the one or more notifications being opened by a respective one of the one or more end users.

17. The computing system of claim 14, wherein the delivery status information includes a first response time by each of the one or more end users during one or more defined timeslots.

18. The computing system of claim 17, further comprising sending, via the notifications service server, at least one additional batch of one or more notifications to the one or more end user notification receiving devices during one or more defined timeslots, wherein each of the one or more notifications of the at least one additional batch are sent to the one or more additional receiving devices at timed intervals during at least one of the one or more defined timeslots based on the first response time of each of the one or more end users.

19. The computing system of claim 18, further comprising redetermining, via the notifications service calculator, the end user notification preference score for each of the one or more end user notification receiving devices using at least one additional response time of each of the one or more end users to the at least one additional batch of one or more notifications.

20. The computing system of claim 18, wherein the sending further comprises scheduling, via the notifications service server, at least one batch job configured to send at least one of the first batch of the one or more notifications or the at least one additional batch of the one or more notifications at regular intervals.
